(19) United States
(12) Patent Application Publication
(10) Pub. No.: US 2009/0216638 A1
(43) Pub. Date: Aug. 27, 2009

(54) System and method for providing consumer directed payment card

(75) Inventors: Mark Matthews, Columbus, GA (US); Connie C. Dudley, Fortson, GA (US); Shannon Hall, Upatoi, GA (US)

Correspondence Address: KING & SPALDING, 1180 PEACHTREE STREET , NE, ATLANTA, GA, 30309-3521, US

(73) Assignee: Total System Services, Inc., Columbus, GA (US)

(21) Appl. No.: 12/321,288

(22) Filed: Jan. 15, 2009

Related U.S. Application Data
(60) Provisional application No. 61/067,290, filed on Feb. 27, 2008.
(60) Provisional application No. 61/069,043, filed on Mar. 12, 2008.

(51) Int. Cl. G06Q 20/00; G06Q 30/00; G06Q 40/00

(52) U.S. Cl. 705/14; 705/41

(57) ABSTRACT

Providing a consumer directed payment card (“CDPC”). Parameters for the CDPC are established in advance of the processing of a transaction to define how transactions are to be processed. The parameters are based on attributes of the transaction, such as transaction value, fund availability, credit availability, merchant type, merchant location, and date. The transaction processes include debit, credit, stored value, installment loan, and other deferred-payment transaction types. Parameters are stored and accessed during a transaction. The appropriate transaction process is determined based on the parameters, and the transaction is processed. A processing platform can be logically connected to a network, banking entity, credit line entity, and a network. The processing platform includes a decision engine, which is logically connected to a decision engine database. The decision engine compares the transaction data to the parameters, and communicates the appropriate transaction process to the processing platform for processing.

### STATEMENT OF RELATED PATENT APPLICATIONS

This non-provisional patent application claims priority under 35 U.S.C. §119 to U.S. Provisional Patent Application No. 61/067,290, titled System and Method for a Consumer Directed Payment Card, filed Feb. 27, 2008, and to U.S. Provisional Application No. 61/069,043, titled System and Method for a Consumer Directed Payment Card, filed Mar. 12, 2008. These provisional applications are hereby fully incorporated herein by reference.

### FIELD OF THE INVENTION

This invention relates to providing a consumer directed payment card. More particularly, this invention relates to processes and systems that allow cardholders to establish how a transaction is processed based on parameters such as, for example, transaction value; merchant type; merchant location; calendar date; available funds; and available credit.

### BACKGROUND OF THE INVENTION

Credit cards, debit cards, and prepaid cards are often used by cardholders at a variety of institutions for performing financial institutions. Typically, a credit card represents a line of credit that has been issued from a financial institution, the account provider, to an individual, the account holder. The credit card allows the account holder to purchase goods and services against the line of credit. The line of credit is associated with an account and that account has certain terms governing how credit is extended to the account holder. Credit cards may be issued by national card brands, such as AMERICAN EXPRESS or DISCOVER CARD; a financial institution in conjunction with a national card association, such as a Bank of America VISA or MASTERCARD; or directly from a retailer, such as MACY'S or BRITISH PETROLEUM. Each credit card can have different terms attached to it, i.e., different interest rates, credit lines, etc. Furthermore, each card could be associated with a different reward program, such as airline miles, hotel rewards, and the like.

In addition to credit cards, debit cards allow an account holder to withdraw funds directly from their bank account. Accordingly, purchases are not made on credit, but with funds in an account linked to the particular debit card. Generally, debit cards are issued by financial institutions.

Prepaid cards provide another method to make purchases. A prepaid card has access to a predetermined amount of funds. The predetermined amount is paid in advance of using the card. Each time it is used, the amount of a purchase is deducted from the prepaid amount.

Because of the various functions of the above-described cards, a consumer typically needs to carry numerous cards with them, i.e. credit, debit, and prepaid cards, in order to perform the desired financial transaction at various institutions. For example, the consumer may wish to process all transactions under a certain dollar amount using a debit card. Further, the consumer may wish to process larger transactions using a particular credit card that is associated with the consumer's favorite airline, in order to accrue airline miles or points. Thus, a consumer must carry each card with them to take advantage of the benefits and functions of the various cards.

This conventional system presents numerous difficulties to the consumer. The consumer must be able to find the desired card and recall various terms that are associated with each card. The consumer can easily forget which card is the appropriate card to use. Further, the consumer may not be aware of fund availability and/or credit availability, which would affect the consumer's card choice. As another difficulty, the consumer cannot determine, in advance, the payment terms for each transaction, i.e., standard credit transactions, 90-day same as cash transactions, 6-month installment payment. All transactions made using a particular card are typically processed in the same manner, regardless of the consumer's preference based on transaction value, merchant type, etc.

Accordingly, a need exists for systems and methods that can allow the consumer to determine how a transaction is to be processed based on consumer-selected parameters, while not requiring the consumer to carry all of their credit, debit, and prepaid cards.

### SUMMARY OF THE INVENTION

The invention supports systems and methods for providing a consumer directed payment card (“CDPC”). The CDPC allows consumers to customize the way purchases are made, by designating parameters based on transaction data. In other words, with a single card, the consumer can make both debit card transactions and credit line transactions that are based on parameters set by the consumer in advance of the processing of the transaction. “Processing” the transaction is used herein to refer to the final processing of the transaction, i.e. the posting of the transaction to the appropriate account, and may occur some time after the consumer and merchant interaction takes place. Thus, after this interaction, a transaction may still be pending until it is processed. The parameters can be based on attributes of the transaction and/or the consumer's accounts. In addition to operating as a debit card or credit card, the CDPC can also operate as a prepaid card, a stored value payroll card, an installment loan program, and another type of financial transaction processing card. Further, the CDPC can operate as multiples of any of the foregoing accounts, i.e. multiple debit card accounts (both coupled and decoupled); multiple credit card accounts, etc. This reduces the number of cards a consumer needs to carry in his or her wallet, and allows the consumer to set parameters based on his or her preferences. This invention also allows a financial institution to issue a multipurpose card to attract consumers and to retain a larger share of the profits. In addition, the consumer or the card issuer can attach reward programs to certain transaction types. Thus, not only is the consumer in control of the way each transaction is processed, but the consumer can specify which transactions will be credited to a reward program.

One aspect of the invention provides a system for processing payments made with a consumer directed payment card, comprising a processing platform operable that is operable to receive instructions from a cardholder associated with the consumer directed payment card to establish values for a set of parameters in advance of processing a financial transaction, wherein the consumer directed payment card operable as at least one of a credit card, a debit card, a prepaid card, a stored value payroll card, an installment loan program, and another type of financial transaction processing card. The system can further receive transaction data related to the financial transaction, where the transaction data comprises a transaction attribute. Upon receipt, the system can identify the consumer directed payment card associated with the transaction data. The system can access the set of parameters associated with the consumer directed payment card, where the set of predetermined parameters define an appropriate transaction process based on the transaction attribute, and where the appropriate transaction process comprises one of: a credit card transaction debit card transaction, a prepaid transaction, a stored value transaction, an installment loan transaction, and another type of deferred payment transaction. The system identifies the appropriate transaction process based on a comparison of the transaction attribute to the set of parameters. The system then processes the transaction using the appropriate transaction process.

Another aspect of the invention provides a method for processing transactions from a consumer directed payment card, comprising the steps of: (a) establishing a consumer-selected parameter associated with the consumer directed payment card in advance of processing one of the transactions, wherein the consumer-selected parameter predefines an appropriate transaction process based on one or more attributes of a transaction, and wherein the consumer directed payment card is operable as at least one of a credit card, a debit card, a prepaid card, a stored value payroll card, an installment loan program, and another type of financial transaction processing card; (b) receiving transaction data comprising one or more attributes of the transaction; (c) identifying the appropriate transaction process based on a comparison of the consumer-selected parameter to the one or more attributes of the transaction, wherein the appropriate transaction process comprises one of: a debit card transaction, a credit card transaction a prepaid transaction, a stored value payroll transaction, an installment loan transaction, and another type of financial transaction; and (d) processing the transaction with a processing platform by using the appropriate transaction process.

Yet another aspect of the invention provides method for processing consumer directed payments, comprising the steps of: (a) receiving instructions from a cardholder associated with a plurality of accounts for a financial card to set a parameter in advance of processing a transaction by the cardholder; (b) setting the parameter associated with the plurality of accounts in advance of processing the transaction, wherein the parameter defines an appropriate transaction process based on one or more attributes of the transaction; (c) accessing the parameter in response to receiving one or more attributes of the transaction, wherein the transaction is initiated with the financial card associated with the plurality of accounts and operable as at least one of a credit card, debit card, a prepaid card, a stored value payroll card, an installment loan program, and another type of financial transaction processing card; (d) performing a comparison between the parameter and the one or more attributes of the transaction to identify the appropriate transaction process, wherein the appropriate transaction process comprises one of: a credit card transaction, a debit card transaction, a prepaid transaction, a stored value payroll transaction, an installment loan transaction, and another type of financial transaction and (e) processing the transaction with a processing platform by using the appropriate transaction process.

### BRIEF DESCRIPTION OF THE DRAWINGS

FIG. 1 depicts a system architecture in accordance with an exemplary embodiment of the present invention.

FIG. 2 depicts an overall process flow diagram for providing a consumer directed payment card in accordance with an exemplary embodiment of the present invention.

FIG. 3 depicts a detailed process flow diagram for a cardholder to set card parameters in accordance with an exemplary embodiment of the present invention.

FIG. 4 depicts a detailed process flow diagram for processing transactions based on card parameters in accordance with an exemplary embodiment of the present invention.

### DETAILED DESCRIPTION OF THE EXEMPLARY EMBODIMENTS

Exemplary embodiments of the present invention are provided. The systems and methods allow for establishment of parameters for the CDPC that define how transactions are processed. The parameters are based on a value of transaction and/or account attributes, such as fund availability, credit availability, transaction value, and merchant type. The transaction processes include debit, credit, prepaid, stored value payroll, installment loan, and other deferred-payment transaction types. Parameters are stored and accessed during a transaction, before processing of the transaction is completed. In other words, a consumer can designate parameters and associated transaction types even after a transaction is initiated, but before it is finally processed and posted to the appropriate account. The appropriate transaction process is identified based on a comparison of the parameters with the transaction data, and the transaction is processed. The systems and methods include a processing platform which is logically connected to a card issuer network, banking entity, credit line entity, and a network. The processing platform includes a decision engine, which is logically connected to a decision engine database which stores the parameters. The decision engine compares the transaction data to the parameters, and communicates the appropriate transaction process to the processing platform for processing.

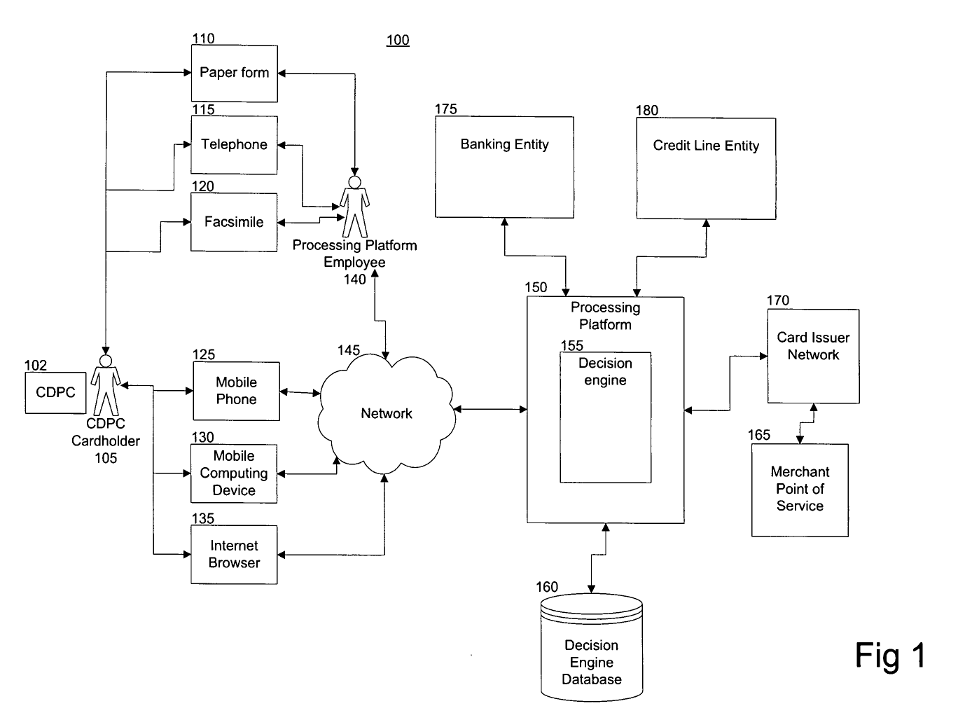

FIG. 1 depicts a system architecture 100 in accordance with an exemplary embodiment of the present invention. Referring to FIG. 1, the system architecture 100 includes a network 145, a processing platform 150, a decision engine 155, a decision engine database 160, an merchant point of service 165, a card issuer network 170, a financial entity 175, and a credit line entity 180.

A CDPC cardholder 105 is in communication with the processing platform 150 through means including a mobile phone 125, a mobile computing device 130, and an internet browser 145. Each of these devices can communicate via a network 145 with the processing platform 150. The network 145 is a communications network, such as a telecommunications network, computer network, or the Internet. In addition, the CDPC cardholder 105 can communicate through can communicate with a processing platform employee 140 via paper form 110, telephone 115, facsimile 120, and/or another form of communication. Through these communications mechanisms, the CDPC cardholder 105 can communicate instructions for processing transactions associated with their accounts. The processing platform employee 140 can communicate these instructions to the processing platform 150 via the network 145 using, for example, a workstation.

A CDPC cardholder 105 is a consumer, or entity, such as a business, that holds a financial account for a consumer directed payment card (“CDPC”) 102. The financial account is associated with the consumer's debit account at the banking entity 175, and a credit line at the credit line entity 180 or the card issuer. Thus, the CDPC 102 is a card that can be used in financial transactions to make both debit and credit card transactions. Additionally, the CDPC 102 can also operate as a prepaid card, a stored value payroll card, an installment loan program, or any other or another type of financial transaction processing card. Additionally, in the present embodiment, the CDPC 102 can operate as multiple accounts of the foregoing options, i.e., multiple debit card accounts (both coupled and decoupled), multiple credit card accounts, etc.

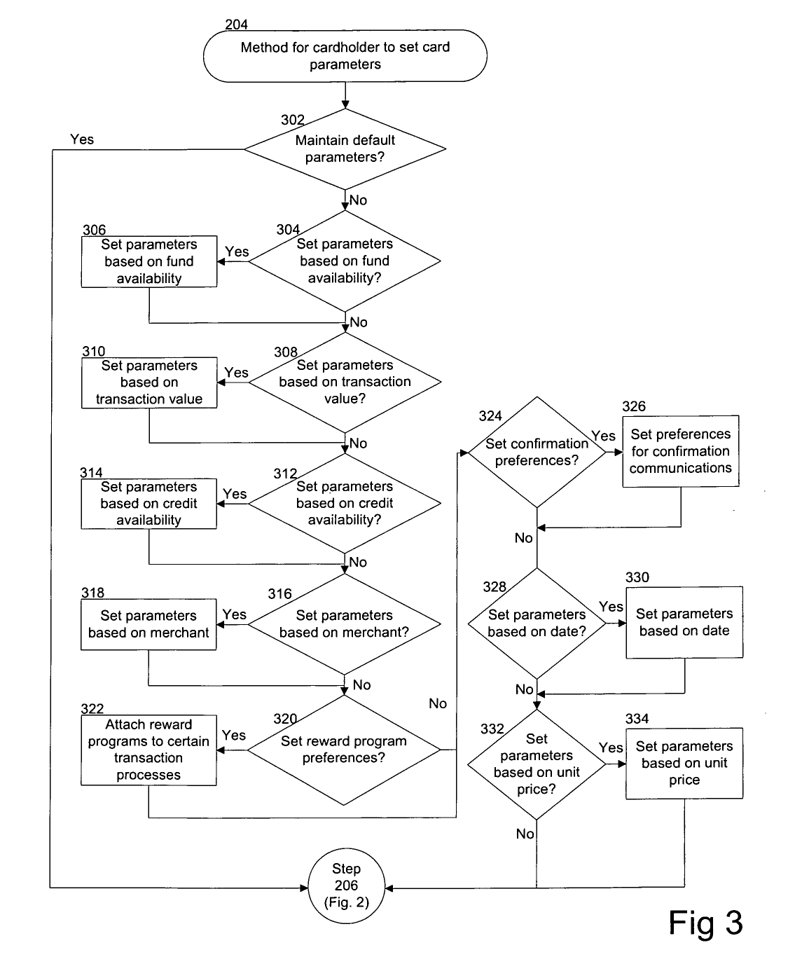

How the CDPC 102 processes a particular transaction is determined by the card's parameters, which can be set by the CDPC cardholder 105. The CDPC cardholder 105 can set the parameters by communicating with the processing platform 150, as discussed above and as depicted in FIG. 1. The CDPC cardholder 105 can log into his or her account using standard login and password identifiers. The process of setting parameters for each CDPC 102 will be described in more detail herein below with reference to FIG. 3.

The processing platform 150 is a framework, associated with the CDPC process, on which applications can be run. The processing platform 150 can access information related to the CDPC 102.

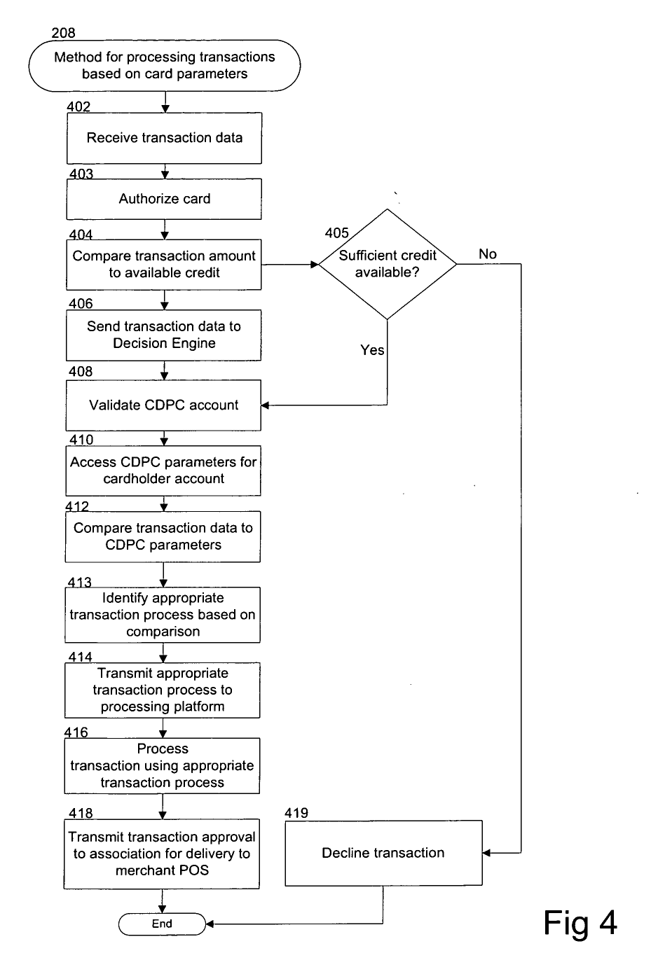

The processing platform 150 includes a decision engine 155. The decision engine 155 is an application that compares, to each transaction, the parameters that are set for each CDPC 102. The decision engine 155 is in communication with a decision engine database 160, which is used to store the parameter settings for each CDPC 102. The processing of transactions in accordance with the stored parameters will be described in more detail herein below with reference to FIG. 4.

The merchant point of service 165 is used herein to refer to the hardware and/or software used for sales between a merchant and a cardholder. A merchant can be any retailer, hotel, restaurant, on-line entity, and/or another type of establishment that is in the business of effecting sales of products and/or services.

The merchant point of service 165 is in communication with a card issuer network 170. The card issuer network 170 is the network associated with the card issuer, i.e. an association such as VISA, MASTERCARD, or a retailer such as MACY'S.

Banking entity 175 is the bank or other type of financial institution associated with the CDPC cardholder 105's demand deposit account, which is used for debit card transactions. Credit line entity 180 is the credit line entity or other type of financial institution associated with the CDPC cardholder 105's credit line account, which is used for credit line transactions. Although depicted as separate entities in FIG. 1, the banking entity 175 and the credit line entity 180 can be one in the same.

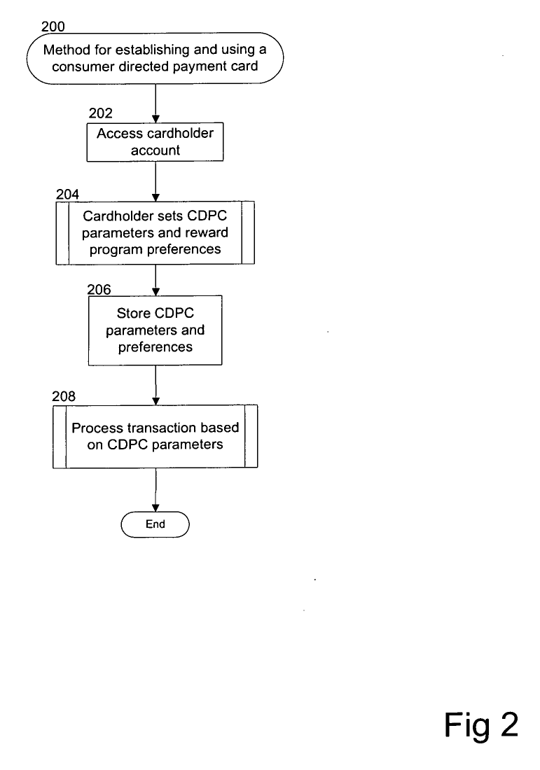

FIG. 2 depicts an overall process flow diagram 200 providing a consumer directed payment card in accordance with an exemplary embodiment of the present invention. Referring to FIG. 1, a process for providing a consumer directed payment card can be described. FIGS. 3 and 4, discussed in detail below, provide additional details on this overall process.

At step 202, a CDPC cardholder 105 accesses the CDPC 102 account. As described above with reference to FIG. 1, the CDPC cardholder 105 accesses the CDPC 102 account by accessing a mobile phone 125, a mobile computing device 130, an internet browser 135, and/or another type of device that can communicate via a network 145. The CDPC cardholder 105 can also use other methods, such as paper form 110, telephone 115, and/or facsimile 120 to access the CDPC 102 account, as described herein above with reference to FIG. 1. The CDPC 102 account information is accessible by the processing platform 150. The CDPC cardholder 105 accesses the CDPC 102 account using a login ID and password.

At step 204, the CDPC cardholder 105 sets the parameters of the CDPC 102 as well as reward program preferences. The parameters determine how a particular transaction is to be processed based on certain attributes of the transaction and/or of the consumer's accounts. Further, the CDPC cardholder 105 can determine which transaction processes will be associated with certain reward programs. Thus, the CDPC 102 is customizable based on the preferences of the CDPC cardholder 105. Step 204 will be described in more detail herein below with reference to FIG. 3. In an alternative embodiment, the reward program parameters can be determined by the card issuer, i.e. VISA, or a retailer such as MACY'S.

At step 206, the decision engine database 106 stores the parameters of the CDPC 102 and reward program preferences set at step 204. As described herein above with reference to FIG. 1, the decision engine database 106 is in communication with the processing platform 150.

At step 208, the processing platform 150 processes transactions based on CDPC 102 parameters. In other words, the processing platform 150 performs the transaction based on the customized parameters selected by the CDPC cardholder 105 at step 204. Step 208 will be described in more detail herein below with reference to FIG. 4.

FIG. 3 depicts a detailed process flow diagram 204 for a cardholder to set CDPC 102 parameters in accordance with an exemplary embodiment of the present invention. The process of setting CDPC 102 parameters can be performed at any time by the CDPC cardholder 105 using any of the methods of communication described herein with reference to FIG. 1. For example, the CDPC cardholder 105 can set parameters using the internet browser 135 after taking part in a financial transaction which is still pending, but before the transaction is processed. Further, the parameters discussed below are exemplary, and other parameters may be set based on other criteria. Referring to FIG. 1, a process for setting card parameters can be described.

At step 302, the CDPC cardholder 105 makes a determination whether to maintain default parameters. Default parameters are those parameters automatically set for the CDPC 102 when the CDPC 102 is initially established. Default parameters can be set by, for example, an account administrator. Default parameters can be based on one or more of the following attributes of a transaction and/or an account: transaction value, fund availability, credit availability, reward type, and merchant type. Accordingly, based on the amount of these attributes, the transaction is processed in a particular way. An example of default parameters based on the attribute of transaction value is shown below:

| Transaction value | Transaction Process |
|---|---|
| < or = $50 | Debit card transaction |
| >$50 and < or = $1,000 | Standard revolving credit transaction |
| >$1,000 and < or = $2,000 | 90-days same as cash transaction, with a |
| | 6-month installment payment for any |
| | remainder |

If, at step 302, the CDPC cardholder 105 makes the determination to maintain all of the default parameters, the method proceeds to step 206 of FIG. 2. The card parameters will be those listed as the default parameters. The method then proceeds as previously described herein.

If, at step 302, the CDPC cardholder 105 makes the determination to change any of the default parameters, the method proceeds to step 304.

At step 304, the CDPC cardholder 105 makes a determination whether to set parameters based on fund availability. For example, in one embodiment, the CDPC cardholder 105 can set parameters to only process transactions as debit card transactions when there is a certain minimum balance available in the CDPC cardholder 105's demand deposit account. As discussed above with reference to FIG. 1, the processing platform 150 is in communication with the banking entity 175 that is the holder of the CDPC cardholder 105's demand deposit account. An example of a parameter based on fund availability set by the CDPC cardholder 105 is shown below:

| Fund availability | Transaction Process |
|---|---|
| <$500 | Credit line transaction |
| >$500 | Debit card transaction |

In another embodiment, the fund availability parameter can be based on whether there are sufficient funds available at the time of the transaction. This embodiment, referred to herein as the “synchronous” system, would entail the decision engine 155 accessing actual fund availability at the time of the transaction. In yet another embodiment, referred to herein as the “asynchronous” system, the fund availability parameter can be based on whether sufficient funds are available according to a nightly batch transfer. The nightly batch transfer reflects all of the transactions for the day associated with the CDPC 102 and reflects the amount of remaining funds available. In this “asynchronous” embodiment, the decision engine 155 would not process the transaction until the nightly batch transfer, in order to determine if there are sufficient funds. If sufficient funds are not available, the transaction can be processed using a different process, i.e. as a credit card transaction. It is also possible, in this asynchronous embodiment, for the decision engine 155 to first confirm whether sufficient credit is available at the time of the transaction, to ensure that the transaction can be processed in the event that sufficient funds are not available for the debit transaction. If sufficient credit is not available, then the transaction is declined. If sufficient credit is available, the decision engine 155 will later confirm whether sufficient funds are available, and process the transaction accordingly. This process is described in detail herein with reference to steps 404-405 of FIG. 4.

The method then proceeds to step 308. At step 308, the CDPC cardholder 105 makes a determination whether to set parameters based on transaction value. An example of parameters based on transaction value was described herein above with reference to step 302.

If, at step 308, the CDPC cardholder 105 makes a determination to set parameters based on transaction value, the method proceeds to step 310.

At step 310, the CDPC cardholder 105 can set parameters based on transaction value. For example, the CDPC cardholder 105 can set a parameter such that all transactions over $500 are processed using a credit line. It should be noted transaction value can also be a component of each of the other types of parameters described herein with reference to FIG. 3. In other words, parameters can be based on more than one attribute of the transaction and/or consumer's accounts.

At step 312, the CDPC cardholder 105 makes a determination whether to set parameters based on credit availability.

If, at step 312, the CDPC cardholder 105 makes the determination to set parameters based on credit availability, the method proceeds to step 314.

At step 314, the CDPC cardholder 105 can set parameters based on credit availability. Because the processing platform 150 is in communication with the credit line entity 180, the amount of available credit is accessible. An example of a parameter based on credit availability is shown below:

| Credit Availability | Transaction Process |
|---|---|
| <$1,000 | Debit card transaction |
| >$1,000 and < or = $5,000 | Standard revolving credit transaction |

The CDPC cardholder 105 may have a preference for maintaining a certain minimum line of credit. Accordingly, parameters set based on credit availability can help the CDPC cardholder 105 maintain such minimums. The CDPC cardholder 105 may also set a parameter that is based on both credit availability and transaction value. Further, as discussed herein with reference to step 304 of FIG. 3, the credit availability parameter can take the form of the “synchronous” or the “asynchronous” system. In the synchronous embodiment, the credit availability parameter can be based on whether sufficient credit is available at the time of the transaction. In the asynchronous embodiment, the credit availability parameter can be based on whether sufficient credit is available according to a nightly batch transfer, and if not, the decision engine 155 can process the transaction using a different process, i.e. a debit card transaction.

At step 316, the CDPC cardholder 105 makes a determination whether to set parameters based on merchant.

If, at step 316, the CDPC cardholder 105 makes the determination to set parameters based on merchant, the method proceeds to step 318.

At step 318, the CDPC cardholder 105 sets parameters based on merchant. Thus, for purchases at different types of merchants, i.e. gas stations, grocers, etc., the CDPC cardholder 105 can predetermine how the transaction will be processed. This may be important to the CDPC cardholder 105 for budgeting and tracking of expenditures. An example of parameters based on merchant type is shown below:

| Category | Transaction Value | Transaction Process |
|---|---|---|
| Fuel | <$50 | Debit account X transaction |
| Groceries | <$100 | Debit account Y transaction |
| Home Improvement | <$200 | Debit account Z transaction |
| Cash | <$1,000 | Credit line transaction |

As show in the example, the transaction can be processed using different accounts of the same type, i.e. different debit accounts, based on the parameter settings. Additionally, at step 318, the CDPC cardholder 105 can set parameters based on the location of the merchant. For example, the CDPC cardholder 105 may want to designate a credit card transaction process for all transactions outside of their home state.

At step 320, the CDPC cardholder 105 makes a determination whether to set reward program preferences. A reward program is used herein to describe a service offered by a business, such as an airline or hotel, to reward customer loyalty. Reward programs generally consist of earning “miles” or “points” which can be redeemed for flights, hotel stays, and the like.

If, at step 320, the CDPC cardholder 105 makes the determination to set reward program preferences, the method proceeds to step 322.

At step 322, the CDPC cardholder 105 can attach certain reward programs to certain transaction processes. Assigning certain transactions to certain reward programs at step 322 allows the CDPC cardholder 105 to customize their reward earnings. For example, for all credit transactions over a certain amount, the cardholder can receive an airline reward, such as miles. For credit transactions under a certain amount, the cardholder can receive a hotel reward, such as points. An example of such rewards is shown below:

| Transaction value | Transaction Process | Reward program |
|---|---|---|
| >$500 | Credit line transaction | Airline miles |
| <$500 | Credit line transaction | Hotel points |

Further, as discussed herein, in an alternative embodiment, the card issuer can set the reward earning parameters.

At step 324, the CDPC cardholder 105 makes a determination whether to set confirmation preferences. A confirmation can include a mobile communication from the processing platform 150 to the CDPC cardholder 105 regarding the confirmation of how a pending transaction is to be processed. The communication can elicit a response from the CDPC cardholder 105 to select the transaction type of a pending transaction. For example, a confirmation communication can include an SMS text message to the CDPC cardholder 105's mobile phone, which reads: “Press 1 to make this a debit transaction or Press 2 to make this a credit transaction.” When the CDPC cardholder 105 responds, the transaction can be processed based on the CDPC cardholder 105 instructions. A CDPC cardholder 105 may find such confirmations useful for certain types of transactions, for which the consumer will need to decide the transaction type during, or shortly thereafter, the transaction itself. Thus, a confirmation preference is another type of parameter set by the consumer.

If, at step 324, the CDPC cardholder 105 makes the determination to set confirmation preferences, the method proceeds to step 326.

At step 326, the CDPC cardholder 105 sets confirmation preferences. The cardholder can choose the type of confirmation to receive, for example, a text message or an e-mail. Additionally, the CDPC 105 cardholder can choose the content of the confirmation. For example, a communication may have content with a query or statement that prompts the CDPC 105 cardholder to select a type of transaction from two types, or ask the CDPC 105 cardholder to confirm one type of transaction.

At step 328, the CDPC cardholder 105 makes a determination whether to set parameters based on date.

If, at step 328, the CDPC cardholder 105 makes the determination to set parameters based on date, the method proceeds to step 330.

At step 330, the CDPC cardholder 105 sets parameters based on date. A parameter based on date can include, for example, setting transactions taking place after the 15^{th} of the month to be processed using a credit card transaction process. The method proceeds to step 332.

At step 332, the CDPC cardholder 105 makes a determination whether to set parameters based on a unit price. A unit price is the price per unit of a particular product purchased during a transaction. For example, for purchases of gasoline, the unit price could be $2.30 per gallon. Thus, a parameter based on unit price can determine the transaction process based on the unit price. An example of a parameter based on unit price is:

| Unit Price | Item | Transaction Process |
|---|---|---|
| >$2.30/gallon | gasoline | Prepaid card account X transaction |
| <$2.30/gallon | gasoline | Debit card account Y transaction |

If, at step 332, the CDPC cardholder 105 makes the determination to set parameters based on unit price, the method proceeds to step 334.

At step 334, the CDPC cardholder 105 sets parameters based on unit price. The method then proceeds to step 206 of FIG. 2.

Referring back to step 304 of FIG. 3, if the CDPC cardholder 105 makes the determination not to set parameters based on fund availability, the method proceeds to step 308, as previously described herein.

Referring back to step 308, if the CDPC cardholder 105 makes the determination not to set parameters based on transaction value, the method proceeds to step 312, as previously described herein.

Referring back to step 312, if the CDPC cardholder 105 makes the determination not to set parameters based on credit availability, the method proceeds to step 316, as previously described herein.

Referring back to step 316, if the CDPC cardholder 105 makes the determination not to set parameters based on merchant type, the method proceeds to step 320, as previously described herein.

Referring back to step 320, if the CDPC cardholder 105 makes the determination not to reward programs to certain transaction processes, the method proceeds to step 324, as previously described herein.

Referring back to step 324, if the CDPC cardholder 105 makes the determination not to set confirmation preferences, the method proceeds to step 328, as previously described herein.

Referring back to step 328, if the CDPC cardholder 105 makes the determination not to set parameters based on date, the method proceeds to step 332, as previously described herein.

Referring back to step 332, if the CDPC cardholder 105 makes the determination not to set parameters based on unit price, the method proceeds to step 206 of FIG. 2.

FIG. 4 depicts a detailed process flow diagram 208 for processing transactions based on CDPC 102 parameters in accordance with an exemplary embodiment of the present invention. Referring to FIGS. 1 and 2, a process for setting card parameters can be described.

At step 402, the processing platform 150 receives transaction data from the card issuer network 170. As described above with reference to FIG. 1, the card issuer network 170 is in communication with the processing platform 150. Accordingly, it can communicate transaction data. Transaction data is used herein to describe attributes associated with each transaction, such as: the value of the transaction; the merchant identification; and the CDPC cardholder 105 information.

At step 403, the merchant point of service 165 communicates with the card issuer network 170 to authorize the CDPC 102 presented by the cardholder to complete the transaction with the merchant.

At step 404, the processing platform 150 compares the transaction amount, which was received as part of the transaction data in step 402, to the CDPC cardholder 105's available credit.

At step 405, a determination is made whether sufficient credit is available for the transaction. If sufficient credit is not available, the method proceeds to step 419 where the transaction is declined, and the method ends.

If, at step 405, a determination is made that sufficient credit is available, the method proceeds to step 406. Thus, steps 404 and 405 can be performed in an exemplary embodiment to ensure that credit is available for the transaction, in the event that sufficient funds are not available for another transaction process. For example, in the asynchronous system described herein with reference to FIG. 3, the processing platform 150 may not verify whether sufficient debit funds are available until the nightly batch transfer. If sufficient funds are not available based on the later nightly batch transfer, the transaction can nonetheless be processed using a credit transaction by verifying the credit availability through steps 404 and 405.

At step 406, the processing platform 150 sends the transaction information to the decision engine 155.

At step 408, the processing platform 150 validates the CPDC and account. The processing platform 150 has access to the account information to validate the account.

At step 410, the decision engine 155 accesses the cardholder's parameters for the CDPC 102 in the decision engine database 160. The CDPC 102 parameters were set in step 204 of FIG. 2 and stored in the decision engine database 160 in step 206 of FIG. 2.

At step 412, the decision engine 155 compares the transaction data received at step 402 to the CDPC 102 parameters that were set in step 204 of FIG. 2. As described above with reference to FIG. 1, the decision engine 155 compares the transaction data to the parameters set by the cardholder. It should be noted, as discussed herein above with reference to FIG. 3, the CDPC cardholder 105 has the ability to access and change the parameters at any time until the transaction is processed. For example, the CDPC cardholder 105 can make changes to parameters that will affect how a transaction is processed while the transaction is still pending, and not marked “posted.” Further, step 412 also includes determining whether the cardholder has set confirmation preferences, which were described herein with reference to steps 324-326 of FIG. 3. Thus, in the event that confirmation preferences had been set, the processing platform 150 can send confirmation, for example, a text message, to the CDPC cardholder 105 at step 412. At step 413, the decision engine 155 identifies the appropriate transaction process based on the comparison performed at step 412. For example, if the cardholder has set the following parameter:

| Category | Transaction Value | Transaction Process |
|---|---|---|
| Fuel | <$50 | Debit card transaction |

and the transaction data indicates a fuel charge of $45, the decision engine 155 will make the determination to process the transaction as a debit card transaction. Alternatively, if the transaction data indicates a fuel charge of $55, the decision engine 155 will make the determination to not process the transaction as a debit card transaction, and to process it as a credit line transaction, or another type of transaction as designated by the cardholder in another parameter. Further, if a parameter is based on fund and/or credit availability, and the system is operating using the “synchronous” system described herein, the decision engine 155 can communicate with the processing platform 150, which can obtain this information from the card issuer network 170, the banking entity 175, and/or the credit line entity 180.

At step 414, the decision engine 155 transmits the appropriate transaction process, identified at step 412, to the processing platform 150, for completion of the transaction.

At step 416, the processing platform 150 completes the transaction using the appropriate transaction process by communicating with the appropriate entity. For example, if the transaction is to be processed as a debit card transaction, the processing platform 150 communicates with the banking entity 175 to effectuate the debit from the cardholder's bank account, for immediate payment. Alternatively, for a credit line transaction, the processing platform 150 can communicate with the credit line entity 180 to effectuate a credit charge, for later payment.

At step 418, the processing platform 150 transmits the transaction approval to the card issuer network 170. The card issuer network 170 is in communication with the merchant point of service 165, and can thus subsequently communicate the approval of the transaction to the merchant. The method then ends.

One of ordinary skill in the art would appreciate that the present invention supports systems and methods for providing a consumer directed payment card. The systems and methods may include the ability to establish a financial account associated with a CDPC 102; set parameters that reflect the consumer's transaction process preference; store the parameters; and process transaction in accordance with the parameters. The systems and methods interact with a processing platform 150, a decision engine 155, and a decision engine database 160.

Although specific embodiments of the present invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed:

1. A system for processing payments made with a consumer directed payment card, comprising a processing platform operable to:
receive instructions from a cardholder associated with the consumer directed payment card to establish values for a set of parameters in advance of processing a financial transaction, wherein the consumer directed payment card is operable as at least one of a credit card, a debit card, a prepaid card, a stored value payroll card, an installment loan program, and another type of financial transaction processing card;
receive transaction data related to the financial transaction, the transaction data comprising a transaction attribute;
identify the consumer directed payment card associated with the transaction data;
access the set of parameters associated with the consumer directed payment card, wherein the set of parameters define an appropriate transaction process based on the transaction attribute, and wherein the appropriate transaction process comprises one of: a credit card transaction, a debit card transaction, a prepaid transaction, a stored value transaction, an installment loan transaction, and another type of deferred payment transaction;
identify the appropriate transaction process based on a comparison of the transaction attribute to the set of parameters; and
process the transaction using the appropriate transaction process.

2. The system according to claim 1, wherein the transaction attribute comprises one of: transaction value; fund availability; credit availability; merchant type; merchant location; unit price; and calendar date.

3. The system according to claim 1, wherein the processing platform is further operable to obtain fund and credit availability information at a time of the transaction.

4. The system according to claim 1, wherein the processing platform is further operable to obtain fund and credit availability information at a time of a batch transfer, wherein the batch transfer is a data transfer comprising daily transactions associated with the consumer directed payment card and reflects a value of fund and credit availability associated with the consumer directed payment card.

5. The system according to claim 1, wherein the consumer directed payment card is associated with at least one financial account.

6. The system according to claim 5, wherein the at least one financial account comprises: a credit line account, a deposit account, a prepaid account, a stored value payroll account, an installment loan account, and another type of financial account.

7. The system according to claim 1, wherein the set of parameters is based on a consumer preference for transaction processes.

8. The system according to claim 1, wherein the set of parameters comprises a value of one or more of: fund availability, credit availability, transaction value, merchant type, merchant location, unit price, and calendar date.

9. The system according to claim 1, further comprising a decision engine operable to perform the comparison of the transaction data to the set of parameters.

10. The system according to claim 9, further comprising a decision engine database operable to store the set of parameters, wherein the decision engine database is in communication with the decision engine.

11. The system according to claim 1, wherein the processing platform processes the transaction by accessing one of: a banking entity and a credit line entity associated with the consumer directed payment card and communicating with a network.

12. The system according to claim 1, wherein each one of the set of parameters is associated with a reward program, and wherein the processing step further comprises crediting the reward program.

13. The system according to claim 1, wherein the instructions from the cardholder can be received at any time interval prior to processing the transaction using the appropriate transaction process.

14. The system according to claim 1, wherein the processing platform is further operable to send a mobile communication to a mobile device of the cardholder in advance of processing the financial transaction, the mobile communication comprising to select the appropriate transaction process.

15. The system according to claim 14, wherein a cardholder selection in response to the mobile communication comprises an indication of the appropriate transaction process.

16. The system according to claim 1, wherein the instructions from the cardholder further comprise instructions to change the values of the set of parameters.

17. A method for processing transactions from a consumer directed payment card, comprising the steps of:
a) establishing a consumer-selected parameter associated with the consumer directed payment card in advance of processing one of the transactions, wherein the consumer-selected parameter predefines an appropriate transaction process based on one or more attributes of a transaction, and wherein the consumer directed payment card is operable as at least one of a credit card, a debit card, a prepaid card, a stored value payroll card, an installment loan program, and another type of financial transaction processing card.
b) receiving transaction data comprising one or more attributes of the transaction;
c) identifying the appropriate transaction process based on a comparison of the consumer-selected parameter to the one or more attributes of the transaction, wherein the appropriate transaction process comprises one of: a debit card transaction and a credit card transaction, a prepaid transaction, a stored value payroll transaction, an installment loan transaction, and another type of financial transaction;
d) processing the transaction with a processing platform by using the appropriate transaction process.

18. The method according to claim 17, wherein the one or more attributes of the transaction comprise: a transaction value; an amount of available funds associated with the financial account; an amount of available credit associated with the financial account; a credit limit associated with the financial account; a merchant type associated with the transaction; a merchant location associated with the transaction; a unit price of a product purchased in the transaction; and a calendar date of the transaction.

19. The method according to claim 18, wherein the attribute of the amount of available funds associated with the financial account can be based on one of: a consumer selected amount, an amount of funds available at a time of the transaction, and an amount of funds available at the time of a batch transfer, wherein the batch transfer reflects a value of fund and credit availability associated with the consumer directed payment card

20. The method according to claim 18, wherein the transaction data is associated with a purchase from a merchant, wherein the merchant is in communication with a network.

21. The method according to claim 20, wherein the network is an association network.

22. The method according to claim 18, wherein the step of receiving transaction data further comprises a communication from the network to a processing platform.

23. The method according to claim 18, wherein the processing step further comprises accessing at least one of: a banking entity and a credit line entity.

24. The method according to claim 18, wherein the consumer-selected parameter is further associated with a reward program, wherein the reward program is an incentive from a business entity.

25. The method according to claim 18, further comprising sending a mobile communication to a mobile device of the consumer in advance of the step of processing the transaction, wherein a consumer response to the mobile communication comprises an identification of the appropriate transaction process.

26. A method for processing consumer directed payments, comprising the steps of:
a) receiving instructions from a cardholder associated with a plurality of accounts for a financial card to set a parameter in advance of processing a transaction by the cardholder;
b) setting the parameter associated with the plurality of accounts in advance of processing the transaction, wherein the parameter defines an appropriate transaction process based on one or more attributes of the transaction;
c) accessing the parameter in response to receiving one or more attributes of the transaction, wherein the transaction is initiated with the financial card associated with the plurality of accounts and operable as at least one of a credit card, debit card, a prepaid card, a stored value payroll card, an installment loan program, and another type of financial transaction processing card;
d) performing a comparison between the parameter and the one or more attributes of the transaction to identify the appropriate transaction process, wherein the appropriate transaction process comprises one of: a credit card transaction, a debit card transaction, a prepaid transaction, a stored value payroll transaction, an installment loan transaction, and another type of financial transaction; and
e) processing the transaction with a processing platform by using the appropriate transaction process.

27. The method according to claim 26, wherein the plurality of accounts comprises: a credit line account, a deposit account, a prepaid account, a stored value payroll account, an installment loan account, and another type of financial account t.

28. The method according to claim 26, wherein the one or more attributes of the transaction comprises: a transaction value; an amount of available funds at the time of the transaction; an amount of available credit at the time of the transaction; a type of merchant associated with the transaction; a location of the merchant associated with the transaction; a unit price associated with a product purchased in the transaction; and a calendar date of the transaction.

29. The system according to claim 26, wherein the parameter associated with the plurality of accounts is further associated with a reward program.

30. The system according to claim 29, wherein the parameter associated with the reward program is determined by at least one of: the cardholder and an issuer of the financial card.

31. The method according to claim 26, wherein the processing step further comprises crediting the reward program associated with the plurality of accounts.

32. The method according to claim 26, wherein the step of receiving instructions from the cardholder associated with the plurality of accounts to set the parameter in advance of processing the transaction by the cardholder can occur at any time in advance of the processing of the transaction.

33. The method according to claim 26, wherein the step of receiving instructions from the cardholder associated with the plurality of accounts to set the parameter in advance of processing the transaction by the cardholder can occur for a predetermined time period in advance of the processing of the transaction.

34. The method according to claim 26, wherein the parameter comprises a selection to receive, by the cardholder associated with the plurality of accounts, a mobile communication comprising a request to confirm the appropriate transaction process, wherein a response to the mobile communication indicates a selection of the appropriate transaction process.

35. The method according to claim 26, further comprising verifying that credit availability associated with the plurality of accounts is sufficient for the transaction, in advance of the step of accessing the parameter.
